(19) United States
(12) Patent Application Publication
(10) Pub. No.: US 2007/0277551 A1
(43) Pub. Date: Dec. 6, 2007

(54) PROCESSES FOR SEPARATING CHLORINE FROM A GAS STREAM CONTAINING CHLORINE, OXYGEN AND CARBON DIOXIDE

(75) Inventor: Friedhelm Kamper, Krefeld (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/749,817

(22) Filed: May 17, 2007

(30) Foreign Application Priority Data
May 19, 2006 (DE) 102006023581.9

(51) Int. Cl. B01D 53/68; F25J 3/00; B01D 47/06

(52) U.S. Cl. 62/617; 423/241; 62/921

(57) ABSTRACT

Processes are disclosed which include: (a) providing a gas comprising chlorine, oxygen, and carbon dioxide; (b) feeding the gas to a distillation column having a head, a bottom, a rectifying section and a stripping section, wherein the gas is fed to the distillation column at an introduction point between the rectifying section and the stripping section; (c) distilling the gas in the column at a pressure of 8 to 30 bar and at a column head temperature of −10° C. to −60° C., to form liquid chlorine and a head mixture comprising carbon dioxide and oxygen; (d) removing the liquid chlorine from the distillation column at the bottom of the column; and (e) removing a first portion of the head mixture from the head of the distillation column, and refluxing a second portion of the head mixture in the column.

### BACKGROUND OF THE INVENTION

In many industrial-scale chemical processes, such as the production of isocyanates, particularly MDI and TDI for example, and in processes for the chlorination of organic substances, chlorine is used as a raw material, and an HCl gas stream is generally produced as a by-product. Such processes are referred to herein generally as isocyanate production processes and/or HCl-generating processes. The HCl gas generated is often contaminated with process-specific organic and inorganic substances. For example, the following are particularly known as impurities in an HCl gas from isocyanate production plants: an excess of carbon monoxide from phosgene production, traces of phosgene, traces of solvents (e.g., toluene, monochlorobenzene or dichlorobenzene), traces of low-boiling, halogenated hydrocarbons and chemically inert components such as nitrogen, carbon dioxide or noble gases.

The following different industrial-scale processes are mentioned here as examples of the production of chlorine and/or the utilisation of the hydrochloric acid formed in an isocyanate production process:

1. The production of chlorine in NaCl electrolyses and utilisation of HCl either by sale or by further processing in oxychlorination processes, e.g., in the production of vinyl chloride.

2. The conversion of HCl to chlorine by electrolysis of aqueous HCl with diaphragms or membranes as a separating medium between the anode and cathode chambers. The coupling product here is hydrogen.

3. The conversion of HCl to chlorine by electrolysis of aqueous HCl in the presence of oxygen in electrolysis cells with an oxygen depletion cathode (ODC). The coupling product here is water.

4. The conversion of HCl gas to chlorine by gas-phase oxidation of HCl with oxygen at elevated temperatures on a catalyst. The coupling product here is also water. This type of process, known as the “Deacon process”, has been in use for more than a hundred years.

Each of these processes offers varying degrees of advantage to isocyanate production depending on the market conditions for the coupling products (e.g., sodium hydroxide solution, hydrogen, vinyl chloride, etc.), on the marginal conditions at the respective site (e.g., energy prices, integration in a chlorine infrastructure) and on capital expenditure and operating costs. The last-mentioned Deacon process is of increasing importance.

A common problem associated with Deacon processes is that a chemical equilibrium between HCl, chlorine and oxygen is established in the reactor, which only allows an HCl conversion of usually about 70 to 90% as a function of pressure, temperature, oxygen excess, residence time and other parameters, i.e., the process gas contains, in addition to the target product chlorine, significant proportions of unreacted HCl and significant quantities of the oxygen used in excess.

Subsequent work-up of this process gas is a central problem in Deacon processes. The goal of subsequent work-up is to remove the target product chlorine selectively from the process gas, which contains only approximately 30 to 50 vol. % chlorine, and to prepare it for reuse, e.g., in isocyanate production, as well as to recycle the residual gas which is as free of chlorine as possible back into the Deacon reactor.

However, conventional processes for chlorine liquefaction under pressure (cf. Ullmanns Encyclopedia of Industrial Chemistry, Chlorine, Wiley VCH Verlag 2006, DOI: 10.1002/14356007.a06_{—}399.pub2) produce a chlorine-containing residual gas, which can only be obtained in a sufficiently chlorine-free condition under extremely low temperature conditions. Part of the chlorine-containing residual gas from the liquefaction has to be removed from the gas circulation of the Deacon process in order to avoid the concentration of inert components in the circulation. The waste-gas washing of this chlorine-containing residual gas that has been removed then has to be carried out generally with sodium hydroxide solution or Na₂SO₃ (of EP 0 406 675 A1), a process that leads to undesirable additional raw material consumption and undesirable quantities of salt in the waste water.

In a process that has become known as the “Shell Deacon process” (see, The Chemical Engineer, (1963), pp. 224-232), chlorine can be obtained in pure form from reaction gases from Deacon processes by absorption/desorption steps with the aid of carbon tetrachloride (CCl₄). The removal of chlorine from a process gas by an absorption in carbon tetrachloride (CCl₄) or other solvents and recovery of the chlorine from the chlorine-containing solvent in an additional desorption step is also known.

The absorption of chlorine in CCl₄ in the presence of the other components of a Deacon reaction gas is not very selective, however, and also requires additional purification steps. Moreover, because of its high ozone-depleting potential, the use of CCl₄ is subject to restrictive international limits for reasons of atmospheric protection.

A further problem associated with such absorption/desorption processes is to obtain sufficiently CCl₄-free recycling gas to avoid negative effects on the Deacon reactor and the Deacon catalyst and to eliminate additional purification steps in the purge gas wash.

Problems associated with the selective removal by distillation of chlorine from a chlorine-containing process gas which additionally contains CO₂ and air have been described. Unfortunately, suggested approaches to addressing such problems which employ a rectifying section in a distillation column, at pressures of about 7 bar, still produce a process gas which contains 5 to 9 vol. % chlorine, and it is thought that the melting point of solid CO₂ (−56.6 C) represents an insuperable barrier.

### BRIEF SUMMARY OF THE INVENTION

The invention relates, in general, to processes for the selective separation of chlorine, for example, from the product gas of an optionally catalyst-supported HCl oxidation process using oxygen, which, in addition to chlorine, also contains at least excess oxygen, chemically inert components, particularly carbon dioxide and noble gases, and optionally HCl, by distillation and recirculation of the oxygen stream freed of chlorine into the HCl oxidation process.

The invention further relates to an improved process gas work-up, e.g., as part of an overall Deacon process, which can be operated particularly advantageously in conjunction with an isocyanate production since the new process gas work-up utilizes impurities in the HCl gas stream from an isocyanate plant.

Processes in accordance with various embodiments of the present invention are capable of selectively removing chlorine from the product of HCl oxidation processes using oxygen and avoids the disadvantages of the processes known from the prior art mentioned above.

One embodiment of the present invention includes a process comprising: (a) providing a gas comprising chlorine, oxygen, and carbon dioxide; (b) feeding the gas to a distillation column having a head, a bottom, a rectifying section and a stripping section, wherein the gas is fed to the distillation column at an introduction point between the rectifying section and the stripping section; (c) distilling the gas in the column at a pressure of 8 to 30 bar and at a column head temperature of −10° C. to −60° C., to form liquid chlorine and a head mixture comprising carbon dioxide and oxygen; (d) removing the liquid chlorine from the distillation column at the bottom of the column; and (e) removing a first portion of the head mixture from the head of the distillation column, and refluxing a second portion of the head mixture in the column.

In various preferred embodiments of the present invention, the gas comprising chlorine, oxygen, and carbon dioxide is a product of a hydrogen chloride oxidation process. In various preferred embodiments of the present invention, the process further comprises feeding the first portion of the head mixture into a hydrogen chloride oxidation process. In still other various preferred embodiments of the present invention, the hydrogen chloride oxidation process from which the gas comprising chlorine, oxygen, and carbon dioxide is a product and the hydrogen chloride oxidation process to which the first portion of the head mixture is fed are the same oxidation process.

Thus, the present invention includes a process for the selective separation of chlorine from the product gas of an optionally catalyst-supported HCl oxidation process using oxygen, which, in addition to chlorine, also contains at least excess oxygen, chemically inert components, particularly carbon dioxide and, for example, noble gases, and optionally HCl, by distillation and recirculation of the oxygen stream freed of chlorine into the HCl oxidation process, characterised in that: the distillation is operated by means of one or more distillation columns which form a rectifying and a stripping section, and wherein the mixture to be separated is fed in between the rectifying and the stripping section of the distillation column; that the distillation is carried out under a pressure of 8 to 30 bar (8000 to 30000 HPa) and at a column head temperature of −10° C. to −60° C.; that liquid chlorine is removed from the distillation column, particularly from the bottom of the column; and that, at the head of the distillation column, a mixture consisting substantially of carbon dioxide and oxygen is formed, part of which is fed into the distillation column as reflux and part of which is removed and fed back into the HCl oxidation process.

In various preferred embodiments of the present invention, the process further comprises feeding at least a portion of the liquid chlorine to an HCl-generating process selected from the group consisting of isocyanate production processes, and organic compound chlorination processes. In still other various preferred embodiments of the present invention, the hydrogen chloride generated in the HCl-generating process can be supplied to a hydrogen chloride oxidation process referenced in any of the aforementioned embodiments.

The gas comprising chlorine, oxygen, and carbon dioxide which is fed into the distillation column is preferably dried before the distillation.

In various preferred embodiments, the HCl oxidation process is a Deacon process, i.e., a gas-phase oxidation of HCl using oxygen in the presence of a suitable catalyst.

### BRIEF DESCRIPTION OF THE SEVERAL VIEWS OF THE DRAWINGS

The foregoing summary, as well as the following detailed description of the invention, will be better understood when read in conjunction with the appended drawings.

For the purpose of illustrating the invention, there is shown in the drawing an embodiment which is presently preferred. It should be understood, however, that the invention is not limited to the precise arrangements and instrumentalities shown.

In the Figs.:

FIG. 1 is a representative flow chart diagram of a process in accordance with an embodiment of the present invention; and

FIG. 2 is a representative process flow diagram of a distillation column operated in accordance with an embodiment of the present invention.

### DETAILED DESCRIPTION OF THE INVENTION

As used herein, the singular terms “a” and “the” are synonymous and used interchangeably with “one or more” or “at least one.” Accordingly, for example, reference to “a gas” herein or in the appended claims can refer to a single gas or more than one gas. Additionally, all numerical values, unless otherwise specifically noted, are understood to be modified by the word “about.”

An HCl gas by-product from isocyanate plants typically contains impurities such as an excess of CO from phosgene production, traces of organic solvents, such as monochlorobenzene or dichlorobenzene, and traces of CO₂. These components can be partly removed in an HCl gas purification system and the remaining traces of carbonaceous compounds can be oxidized with oxygen to form CO₂ under the reaction conditions of a Deacon process (excess oxygen, elevated temperatures of 300-400° C.). In known processes, the CO₂ generally becomes concentrated as an inert gas in the oxygen recycling gas stream from the Deacon process and has to be removed from the oxygen circulation (purge).

If the quantity of carbon dioxide removed from the oxygen recycling stream is too high, the CO₂ content in the recycling gas stream remains low, but then large quantities of oxygen and possibly other components are also lost with the purge gas stream.

If the quantity removed is too low, CO₂ is concentrated in the recycling stream and increases the quantity of recycling gas and thus the capital expenditure and operating costs for the entire gas path.

The CO₂ content in such recycling gases makes it possible, by employing a process in accordance with the present invention, to condense in a distillation column the CO₂ contained in a quenched and dried product gas from a Deacon reactor, at a pressure of 10-30 bar and at a temperature of about −30° C. to −55° C., and to feed it into the column as reflux. The additional energy input to produce deep cooling can be markedly lessened in this process using suitable cold recovery measures that are known in principle.

Also preferred, therefore, is an embodiment of a process in accordance with the present invention which embodiment is characterised in that the hydrogen chloride from the HCl oxidation process comes from an isocyanate production process and the purified chlorine is fed back into the isocyanate production process.

Another preferred embodiment of a process in accordance with the present invention is an embodiment in which the hydrogen chloride from the HCl oxidation process comes from processes for the chlorination of organic compounds, e.g., the production of chlorinated aromatics, and the chlorine purified in the process is fed back into the chlorination process.

Distillation in accordance with various embodiments of the present invention is preferably operated under a pressure of 10 to 25 bar (10000 to 25000 HPa) and at a temperature at the column head of −25° C. to −45° C.

The distillation column operated in accordance with a process according to the present invention selectively removes the desired product, chlorine, as a bottom product from the distillation. Owing to the reflux of liquid CO₂, preferably, the head of the column and therefore also the oxygen recycling stream is chlorine-free; apart from excess oxygen it contains Only CO₂ and inert components and in principle, therefore, it can be released to the atmosphere without waste gas washing.

In a particularly preferred embodiment of a process according to the present invention, during the distillation the bottom of the distillation column consists of liquid chlorine and is substantially free of low-boiling compounds from the series of oxygen, carbon dioxide, nitrogen, optionally noble gases and optionally hydrogen chloride.

In another particularly preferred embodiment of a process according to the present invention, the mixture forming at the head of the distillation column is substantially free of all other compounds except carbon dioxide, oxygen and hydrogen chloride, and is fed into the distillation column as reflux.

The mixture forming at the head of the distillation column particularly preferably contains all low-boiling compounds from the series of oxygen, carbon dioxide, nitrogen, optionally noble gases and optionally hydrogen chloride and is substantially chlorine-free.

“Substantially chlorine-free” and “substantially free of chlorine” as used herein refers to a residual chlorine content of no more than 0.001 vol. %, preferably 0.0002 vol. %.

In various preferred embodiments, the new process requires a sufficiently high CO₂ partial pressure so that a condensate of liquid CO₂ can be produced at the head of the column. In the event of the start-up of an upstream Deacon process, an external feed of CO₂ may therefore be necessary. In continuous operation, an equilibrium is established with regard to the CO₂ concentration, which is regulated by the quantity of purge gas removed.

A particularly preferred process embodiment is thus characterised in that the content of carbon dioxide in the area of the condenser outlet after the column head of the distillation column, including in particular during start-up of the HCl oxidation upstream of the distillation, is in the range of 20 to 70 vol. %, particularly preferably 30 to 50 vol. %.

According to a further preferred embodiment of processes according to the invention, HCl can additionally be fed into the column for the purposes of economic optimization. The quantity of HCl fed into the column increases the partial pressure of the readily condensable components CO₂ and HCl in the overhead condenser of the column and thus permits more economical operation by establishing a lower column pressure or a higher condensation temperature or both.

To increase the condensation temperature in the column head and optionally to lower the overall pressure, in an especially preferred embodiment of the process, hydrogen chloride, in particular from the upstream HCl oxidation process, can be added to the input stream of the distillation column as HCl gas and/or can be added to the overhead condenser of the distillation column together with the column vapours.

Up to 30 vol. % of the pre-purified HCl gas from the upstream HCl oxidation process is especially preferably diverted before the HCl oxidation and added to the distillation of the product mixture from the HCl oxidation.

In a particularly preferred embodiment of a process according to the invention, therefore, a bypass of purified HCl gas is set up around the reactor directly to the distillation column, both for the process start-up and for the subsequent continuous operation. In this case, no external CO₂ feed is necessary for start-up with a low CO₂ content. The quantitative proportion of this bypass stream is up to 30 vol. % of the total quantity of HCl.

The HCl bypass stream is advantageously fed directly to the overhead condenser of the distillation column; an optional feed of the HCl bypass stream into the inlet of the distillation column is also possible.

In the event of HCl being fed to the head of the column, the recycling gas contains HCl but is not yet chlorine-free. The waste gas of the purge stream can then be washed very simply with water. The recovered aqueous HCl can be reused particularly in the isocyanate production/Deacon process combination.

If relatively large quantities of HCl are fed into the distillation column, the input stream of the dry process gas into the column may very well contain HCl. As a result of this measure, the cost of purification for the process gas in the quench is also reduced.

The pressure of typically about 20 bar required for economical condensation in the column can advantageously be utilised in the entire gas path of the process, including the upstream Deacon reactor. A pressure of about 20 bar is advantageous for a Deacon reaction, since too high a pressure results in increased HCl conversion in the reactor by shifting the chemical equilibrium.

The recycling gas from the preferred process fed back e.g., to the Deacon reactor is free from chlorine and water, which means that the HCl conversion can thus be maximised owing to the chemical equilibrium in the Deacon reactor.

In a first step of a preferred process embodiment, which provides the integration of the new combined chlorine purification process into an isocyanate production, the production of phosgene takes place by the reaction of chlorine with carbon monoxide. The synthesis of phosgene is adequately known and is set out e.g., in Ullmanns Enzyklopädie der industriellen Chemie, 3rd edition, volume 13, pages 494-500. On an industrial scale, phosgene is predominantly produced by the reaction of carbon monoxide with chlorine, preferably on activated carbon as catalyst. The strongly exothermic gas-phase reaction typically takes place at a temperature of at least 250° C. to a maximum of 600° C., generally in shell-and-tube reactors. The dissipation of the heat of reaction can take place in various ways, e.g., using a liquid heat exchanger as described e.g., in the document WO 03/072237 A1, the entire contents of which are incorporated herein by reference, or by evaporation cooling via a secondary cooling circulation with simultaneous utilisation of the heat of reaction to produce steam, as disclosed e.g., in U.S. Pat. No. 4,764,308, the entire contents of which are incorporated herein by reference.

From the phosgene formed in the first step, at least one isocyanate can be formed in a next process step by reaction with at least one organic amine or a mixture of two or more amines. This second process step is also referred to below as phosgenation. The reaction takes place with the formation of hydrogen chloride as a by-product, which occurs as a mixture with the isocyanate.

The synthesis of isocyanates is also known in principle from the prior art, phosgene generally been used in a stoichiometric excess based on the amine. According to the phosgenation generally takes place in the liquid phase, it being possible for the phosgene and the amine to be dissolved in a solvent. Preferred solvents for the phosgenation are chlorinated aromatic hydrocarbons, such as chlorobenzene, o-dichlorobenzene, p-dichlorobenzene, trichlorobenzenes, the corresponding chlorotoluenes or chloroxylenes, chloroethylbenzene, monochlorodiphenyl, α- or β-naphthyl chloride, ethyl benzoate, dialkyl phthalates, diisodiethyl phthalate, toluene and xylenes. Further examples of suitable solvents are known in principle from the prior art. As is also known from the prior art, e.g., according to the document WO 96/16028, the resulting isocyanate itself can also act as a solvent for phosgene. In another preferred embodiment, the phosgenation particularly of suitable aromatic and aliphatic diamines takes place in the gas phase, i.e., above the boiling point of the amine. Gas-phase phosgenation is described e.g., in EP 570 799 A1, the entire contents of which are incorporated herein by reference. Advantages of this process compared with the otherwise conventional liquid-phase phosgenation lie in the energy saving brought about by the minimising of an expensive solvent and phosgene circulation.

In principle, all primary amines with one or more primary amino groups that can react with phosgene to form one or more isocyanates with one or more isocyanate groups are suitable as organic amines. The amines have at least one, preferably two or optionally three or more primary amino groups. Thus, aliphatic, cycloaliphatic, aliphatic-aromatic and aromatic amines, diamines and/or polyamines, such as aniline, halogen-substituted phenylamines, e.g., 4-chlorophenylamine, 1,6-diaminohexane, 1-amino-3,3,5-trimethyl-5-aminocyclohexane, 2,4-, 2,6-diaminotoluene or mixtures thereof, 4,4′-, 2,4′- or 2,2′-diphenylmethanediamine or mixtures thereof, as well as higher molecular weight isomeric, oligomeric or polymeric derivatives of said amines and polyamines, are suitable as organic primary amines. Other possible amines are known in principle from the prior art. Preferred amines for the present invention are the amines of the diphenylmethanediamine series (monomeric, oligomeric and polymeric amines), 2,4-, 2,6-diaminotoluene, isophorone diamine and hexamethylene diamine. In the phosgenation, the corresponding isocyanates diisocyanatodiphenylmethane (MDI monomeric, oligomeric and polymeric derivatives), toluene diisocyanate (TDI), hexamethylene diisocyanate (HDI) and isophorone diisocyanate (IPDI) are obtained.

The amines can be reacted with phosgene in a one-step or two-step, or optionally a multi-step, reaction. A continuous or batchwise method of operation is possible.

If a one-step phosgenation in the gas phase is selected, the reaction takes place above the boiling point of the amine, preferably within an average contact period of 0.5 to 5 s and at a temperature of 200 to 600° C.

The phosgenation in the liquid phase is generally carried out at a temperature of 20 to 240° C. and under a pressure of 1 to about 50 bar. The phosgenation in the liquid phase can be carried out in one step or in two steps, it being possible to use phosgene in a stoichiometric excess. In this case the amine solution and the phosgene solution are combined using a static mixing element and then for example passed from bottom to top through one or more reaction towers where the mixture reacts completely to form the desired isocyanate. In addition to reaction towers provided with suitable mixing elements, reaction vessels with an agitator device can also be used. In addition to static mixing elements, special dynamic mixing elements may also be employed. Suitable static and dynamic mixing elements are known in principle from the prior art.

The continuous liquid-phase production of isocyanate on an industrial scale is generally carried out in two steps. In the first step, generally at a temperature of no more than 220° C., preferably no more than 160° C., carbamoyl chloride is formed from amine and phosgene and amine hydrochloride is formed from amine and hydrogen chloride that has been split off. This first step is strongly exothermic. In the second step, both the carbamoyl chloride is split to form isocyanate and hydrogen chloride and the amine hydrochloride is reacted to form carbamoyl chloride. The second step is generally carried out at a temperature of at least 90° C., preferably of 100 to 240° C.

After the phosgenation, the separation of the isocyanates formed during the phosgenation takes place in a third step. This takes place by initially separating the reaction mixture of the phosgenation into a liquid and a gaseous product stream in a manner that is known in principle to the person skilled in the art. The liquid product stream substantially contains the isocyanate or isocyanate mixture, the solvent and a small portion of unreacted phosgene. The gaseous product stream consists substantially of hydrogen chloride gas, stoichiometrically excess phosgene and small quantities of solvent and inert gases, such as e.g., nitrogen and carbon monoxide. In addition, the liquid stream is then fed to a work-up, preferably by distillation, wherein phosgene and the solvent for the phosgenation are separated off consecutively. An additional work-up of the isocyanates formed can optionally also take place. This is achieved for example by fractionating the isocyanate product obtained in a manner that is known to the person skilled in the art.

The hydrogen chloride obtained in the reaction of phosgene with an organic amine generally contains organic secondary components, which can be problematic both in the thermal catalysed or non-thermal activated HCl oxidation and in the electrochemical oxidation of an aqueous hydrogen chloride solution. These organic components include for example the solvents used in the isocyanate production, such as chlorobenzene, o-dichlorobenzene or p-dichlorobenzene. If a gas diffusion electrode is used as the cathode during the electrolysis, the catalyst of the gas diffusion electrode can also be deactivated by the organic impurities. Furthermore, these impurities can be deposited on the current collector, thus impairing the contact between gas diffusion electrode and current collector, which results in an undesirable increase in voltage. If the diaphragm process is used for the electrolysis of the hydrochloric acid, said organic components can be deposited on the graphite electrodes and/or the diaphragm, thus also increasing the electrolysis voltage.

Accordingly, in another process step, the hydrogen chloride produced during the phosgenation is preferably separated from the gaseous product stream. The gaseous product stream obtained during the separation of the isocyanate is treated in such a way that the phosgene can be fed back into the phosgenation and the hydrogen chloride can be fed into an electrochemical oxidation.

The separation of the hydrogen chloride preferably takes place by initially separating phosgene from the gaseous product stream. The phosgene is separated off by liquefying phosgene, e.g., on one or more condensers connected in series. The liquefaction preferably takes place at a temperature in the range of −15 to −40° C. depending on the solvent used. As a result of this deep cooling, parts of the solvent residues can also be removed from the gaseous product stream.

In addition or alternatively, the phosgene can be washed out of the gas stream in one or more steps with a cold solvent or solvent-phosgene mixture. Suitable solvents for this purpose are for example the solvents already used in the phosgenation, chlorobenzene and o-dichlorobenzene. The temperature of the solvent or of the solvent-phosgene mixture for this purpose is in the range of −15 to −46° C.

The phosgene separated from the gaseous product stream can be fed back to the phosgenation. The hydrogen chloride obtained after separating off the phosgene and part of the solvent residue can still contain 0.1 to 1 wt. % solvent and 0.1 to 2 wt. % phosgene in addition to the inert gases such as nitrogen and carbon monoxide.

Purification of the hydrogen chloride can then optionally take place to reduce the proportion of traces of solvent. This can take place for example by freezing, by passing the hydrogen chloride e.g., through one or more cold traps depending on the physical properties of the solvent.

In a particularly preferred embodiment of the optional purification of the hydrogen chloride, the hydrogen chloride stream flows through two heat exchangers connected in series, the solvent to be separated off being frozen out as a function of the freezing point e.g., at −40° C. The heat exchangers are preferably operated alternately, the gas stream thawing the previously frozen solvent in the heat exchanger through which it flows first in each case. The solvent can be reused for the production of a phosgene solution. In the second downstream heat exchanger, which is supplied with a conventional heat exchanger medium for cooling equipment, e.g., a compound from the Frigen series, the gas is preferably cooled to below the freezing point of the solvent so that this crystallises out. On completion of the thawing and crystallisation operation, the gas stream and the coolant stream are switched so that the function of the heat exchangers is reversed. The gas stream containing hydrogen chloride can be depleted in this way to preferably no more than 500 ppm, particularly preferably no more than 50 ppm, especially preferably no more than 20 ppm solvent content.

Alternatively, the purification of the hydrogen chloride can preferably take place in two heat exchangers connected in series, e.g., according to U.S. Pat. No. 6,719,957, the entire contents of which are incorporated herein by reference. The hydrogen chloride is preferably compressed to a pressure of 5 to 20 bar, preferably 10 to 15 bar, in this case and the compressed, gaseous hydrogen chloride is fed into a first heat exchanger at a temperature of 20 to 60° C., preferably 30 to 50° C. Here, the hydrogen chloride is cooled with a cold hydrogen chloride at a temperature of −10 to −30° C., which comes from a second heat exchanger. This brings about the condensation of organic components, which can be disposed of or recycled. The hydrogen chloride passed into the first heat exchanger leaves it at a temperature of −20 to 0° C. and is cooled in the second heat exchanger to a temperature of −10 to −30° C. The condensate produced in the second heat exchanger consists of further organic components and small quantities of hydrogen chloride. To avoid the loss of hydrogen chloride, the condensate leaving the second heat exchanger is fed into a separating and evaporating unit. This can be a distillation column, for example, in which the hydrogen chloride is driven off from the condensate and returned to the second heat exchanger. It is also possible to return the hydrogen chloride that has been driven off to the first heat exchanger. The hydrogen chloride cooled in the second heat exchanger and freed of organic components is passed into the first heat exchanger at a temperature of −0 to −30° C. After heating to 10 to 30° C., the hydrogen chloride freed of organic components leaves the first heat exchanger.

In an alternative process that is also preferred, the optional purification of the hydrogen chloride of organic impurities, such as solvent residues, takes place on activated carbon by adsorption. In this process, for example, the hydrogen chloride is passed over or through an activated carbon bed after removing excess phosgene at a pressure difference of 0 to 5 bar, preferably of 0.2 and 2 bar. The flow rate and residence time are adapted to the content of impurities in a manner known to the person skilled in the art. The adsorption of organic impurities is also possible on other suitable adsorbing agents, e.g., on zeolites.

In another alternative process that is also preferred, a distillation of the hydrogen chloride can be provided for the optional purification of the hydrogen chloride from the phosgenation. This takes place after condensation of the gaseous hydrogen chloride from the phosgenation. In the distillation of the condensed hydrogen chloride, the purified hydrogen chloride is removed from the distillation as the overhead product, the distillation taking place under conditions of pressure, temperature etc. that are known to the person skilled in the art and conventional for a distillation of this type.

The hydrogen chloride separated by the processes set out above and optionally purified can then be fed into the HCl oxidation with oxygen.

The following examples are for reference and do not limit the invention described herein.

### EXAMPLES

### Example 1

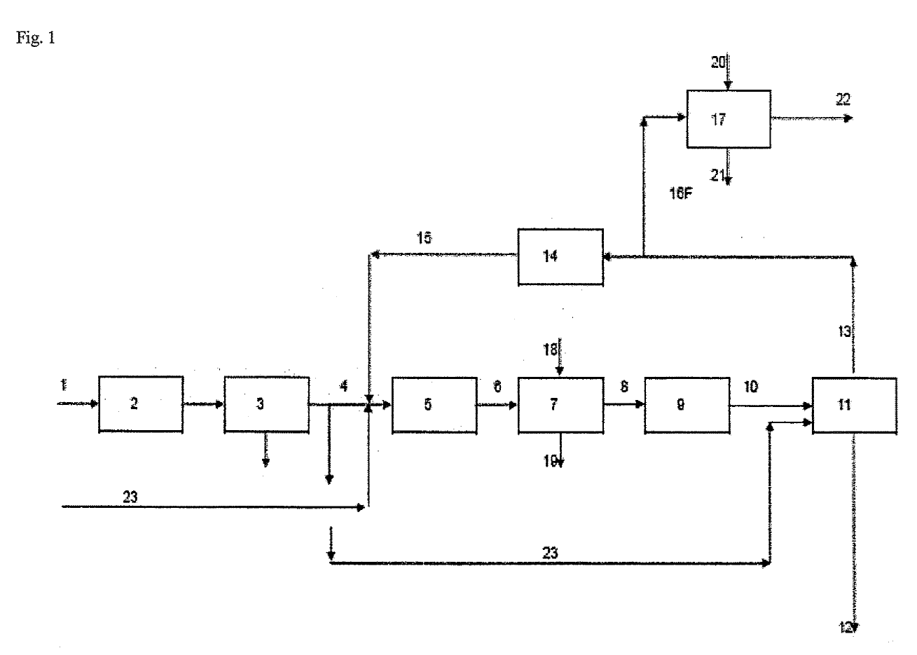

Referring to FIG. 1, HCl gas 1 from an isocyanate plant for the production of methylene diisocyanate, typically consisting of >99 vol. % HCl, <0.2 vol. % CO, <500 vol. ppm organic compounds (monochlorobenzene, dichlorobenzene etc.) and inert trace gases are compressed to 22 bar in a compression system 2.

In a downstream low-temperature gas purification system 3, the chief portion of the organic impurities is removed from the HCl gas.

The greater part (85%) of the purified HCl gas 4 is fed into a Deacon reactor 5 together with an excess of oxygen 23 and the recycling gas from the chlorine separation 15. In this reactor the HCl gas is catalytically oxidised to chlorine at 370° C.

The process gas 6 from the reaction contains as its main components chlorine, oxygen and water of reaction together with unreacted HCl gas, carbon dioxide and inert gases.

The hot process gas is fed into a suitable quench 7 in which, by reducing the temperature to about 40-90° C., the water of reaction condenses out together with the majority of the unreacted HCl as an aqueous concentrated HCl solution.

The moist process gas 8, still containing HCl, is dried in a gas dryer 9 with concentrated sulfuric acid as the drying medium.

After being cooled, the dried process gas 10 is fed into a distillation column 11 with a rectifying and a stripping section. In the column operated at an overhead pressure of 20 bar, a liquid mixture of CO₂, HCl and small proportions of other components, such as oxygen and inert gases, condenses at the head at about −32° C. and is fed into the column as reflux. As a result, the head of the column as well as the oxygen-containing recycling gas 13 produced there becomes completely chlorine-free.

In the bottom 12 of the column, liquid chlorine free of low-boilers is drawn off and can be reused in the isocyanate plant (not shown).

The remaining quantity (15%) of the purified HCl gas from the gas purification system 3 is fed as bypass 23 around the Deacon reaction together with the vapours from the distillation column 10 directly to the overhead condenser of the column.

The recycling gas 13, consisting of 40 vol. % oxygen, 36 vol. % CO₂, 20 vol. % HCl and 4 vol. % inert components, is fed back into the Deacon reactor 5 via a compressor 14.

The by-products becoming concentrated in the recycling gas over time, such as CO₂ and other inerts, are removed from the recycling gas 16 and purified of HCl in a water wash 17. The dilute aqueous hydrochloric acid 21 discharged is reused at another point in the process combination of isocyanate plant and Deacon process.

The waste gas 22, free of chlorine and HCl and consisting of 50 vol. % oxygen, 45 vol. % CO₂ and 5 vol. % inerts is discharged to the atmosphere.

### Operation of the Distillation Column in Example 1

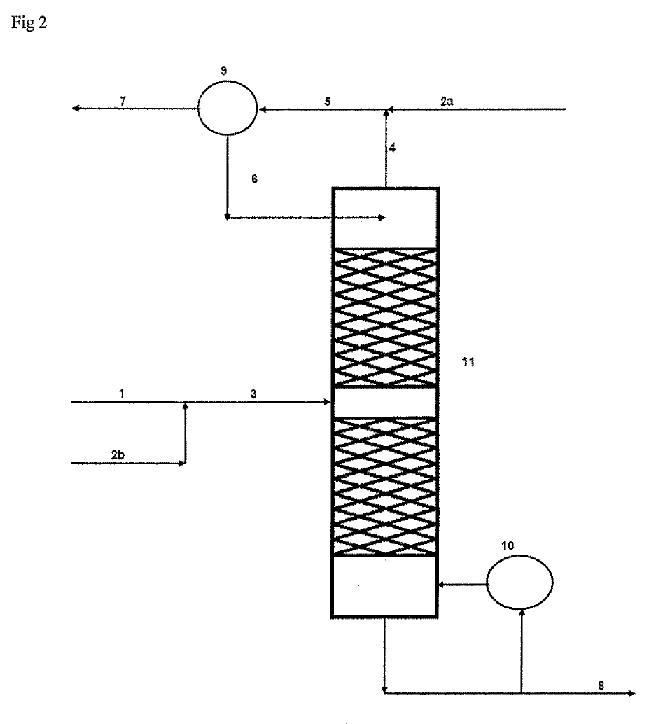

Referring to FIG. 2, the dried process gas from the Deacon reactor 1, consisting of 47 vol. % Cl₂, 31 vol. % O₂, 19 vol. % CO₂, 2 vol. % inert gases and 1 vol. % HCl, is fed into a distillation column 11 with a rectifying section and a stripping section. The column is operated at an overhead pressure of 20 bar and an overhead temperature of −32 C; the bottom temperature is +64 C.

At the bottom of the column, the pure, liquid chlorine 8 is removed and partly returned to the column 11 via an evaporator 10.

The low boilers oxygen, HCl, CO₂ and inerts are carried through at the head of the column 4 and are mixed there with the HCl bypass stream from the HCl purification 2a and fed to a condenser 9. The quantity of HCl bypass is 15% of the total quantity of HCl to be oxidised.

In the condenser 9, the gases that are condensable under these pressure and temperature conditions are condensed out. The condensate 6, consisting of 50 wt. % CO₂, 38 wt. % HCl and 12 wt. % oxygen, is fed into the column as reflux. The components that are not condensable in the condenser are fed back to the Deacon reactor as an oxygen recycling stream 7 consisting of 40 vol. % O₂, 36 vol. % CO₂, 20 vol. % HCl and 4 vol. % inerts.

### Example 2 (cf. FIG. 2)

The procedure as in Example 1 is used but the HCl bypass stream 2b is fed not to the overhead condenser 9 but to the column inlet together with the dried process gas 1.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(a) providing a gas comprising chlorine, oxygen, and carbon dioxide, wherein the gas is a product of a hydrogen chloride oxidation process;
(b) feeding the gas to a distillation column having a head, a bottom, a rectifying section and a stripping section, wherein the gas is fed to the distillation column at an introduction point between the rectifying section and the stripping section;
(c) distilling the gas in the column at a pressure of 8 to 30 bar and at a column head temperature of −10° C. to −60° C., to form liquid chlorine and a head mixture comprising carbon dioxide and oxygen;
(d) removing the liquid chlorine from the distillation column at the bottom of the con; and
(e) removing a first portion of the head mixture from the head of the distillation column, and refluxing a second portion of the head mixture in the column.

2. The process according to claim 1, further comprising feeding the first portion of the head mixture into the hydrogen chloride oxidation process.

3. The process according to claim 1, wherein the head mixture is substantially free of chlorine.

4. The process according to claim 1, further comprising drying the gas prior to distilling the gas.

5. The process according to claim 1, wherein the hydrogen chloride oxidation process comprises a gas phase oxidation with oxygen at an elevated temperature in the presence of a catalyst.

6. The process according to claim 1, further comprising feeding at least a portion of the liquid chlorine to an HCl-generating process selected from the group consisting of isocyanate production processes, and organic compound chlorination processes.

7. The process according to claim 1 wherein the hydrogen chloride oxidation process is supplied with hydrogen chloride from an HCl-generating process selected from the group consisting of isocyanate production processes, organic compound chlorination processes and combinations thereof; and wherein the process further comprises feeding at least a portion of the liquid chlorine to the HCl-generating process.

8. The process according to claim 1, wherein the distillation is carried out at a pressure of 10 to 25 bar and at a column head temperature of −25° C. to −45° C.

9. The process according to claim 1, wherein the liquid chlorine is substantially free of low-boiling compounds selected from the group consisting of oxygen, carbon dioxide, nitrogen, noble gases, and hydrogen chloride.

10. The process according to claim 1, wherein the head mixture further comprises hydrogen chloride.

11. The process according to claim 1, wherein all low-boiling compounds selected from the group consisting of oxygen, carbon dioxide, nitrogen, noble gases, and hydrogen chloride are present in the head mixture after distillation and wherein the head mixture is substantially free of chlorine.

12. The process according to claim 1, further comprising adding hydrogen chloride gas to an addition point selected from the gas prior to introduction into the distillation column, a condenser proximate to the column head, and combinations thereof.

13. The process according to claim 12, wherein up to 30 vol. % of the hydrogen chloride gas supplied to the first hydrogen chloride oxidation process is diverted prior to oxidation and is reintroduced into the gas prior to the distillation.

14. The process according to claim 1, the carbon dioxide in the first portion of the head mixture is 20 to 70 vol. %.
